(19) United States
(12) Patent Application Publication
(10) Pub. No.: US 2008/0044542 A1
(43) Pub. Date: Feb. 21, 2008

(54) READY TO EAT COOKIE DOUGH

(75) Inventors: Donna Reeves-Collins, Pittsford, NY (US); William O. Collins, Pittsford, NY (US)

Correspondence Address: Stephen B. Salai, Esq.;Harter, Secrest & Emery LLP, 1600 Bausch & Lomb Place, Rochester, NY, 14604-2711, US

(73) Assignee: Cole and Parks, Fishers, NY (US)

(21) Appl. No.: 11/842,637

(22) Filed: Aug. 21, 2007

Related U.S. Application Data
(60) Provisional application No. 60/823,039, filed on Aug. 21, 2006.

(51) Int. Cl. A21D 10/04

(52) U.S. Cl. 426/549

(57) ABSTRACT

A ready-to-eat frozen cookie dough which is prepared from flour, butter, sugar and contains no egg, baking soda or baking powder. It is provided in a bite-sized cone-shaped cookie dough that is safe (and intended) to eat raw and formed in a size that is convenient for snacking or mixing into other products such as ice cream

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present invention relates to a ready-to-eat cookie dough confection which is preserved in the freezer and which is prepared from flour, sugar and butter, with no egg.

Cookie doughs already conventionally exist on the market which are ready-to-bake. Such dough are intended to be balked and present some level of risk in eating, as they contain egg products that are required in the balking process. Accordingly, there is a need in the art for a dough formulated without egg and other ingredients. There is also a need in the art for a cookie dough formed in bite-sized portions, which are substantially cone-shaped and easy for a consumer to select as a frozen treat or as an addition to, for example, a dish of any flavored ice cream, for a customized “cookie dough” ice cream treat.

### BRIEF SUMMARY OF THE INVENTION

The present invention provides the consumer with a cookie dough confection that is ready-to-eat. It is intended to eat or for mixing into ice cream, is made without any egg product, and is safe for consumption directly from the package. This invention provides the consumer with ready-to-eat cookie dough formulated in small, bite-sized cookie dough portions that are easy to pop in their mouth or mix into other foods. The cone-shape cookie dough allows the pieces to break apart more easily when frozen, helps to allow more air flow around the cookie dough piece when eating, is easier to eat than a “glob” or “block” and creates a soothing mouth-feel for the consumer.

In addition, the cookie dough can be provided with a chocolate, caramel or candy coating. Moreover, additives, including chocolate, caramel, nuts, and candy may be drizzled over, sprinkled on top of, completely covering, or included with the cookie dough.

### BRIEF DESCRIPTION OF THE DRAWINGS

Preferred embodiments of the invention will be described in the following detailed description and appended drawing figures, wherein:

FIG. 1 is a perspective view of a bite sized, cone-shaped ready-to-eat cookie dough piece.

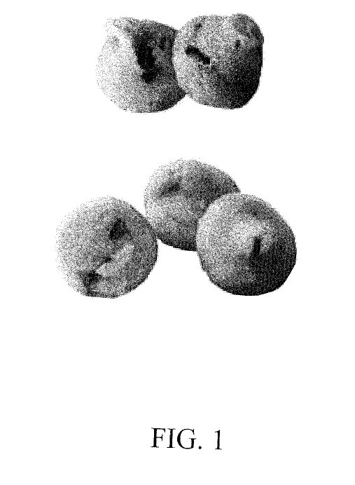

FIG. 2 is a series of pictures of the production process.

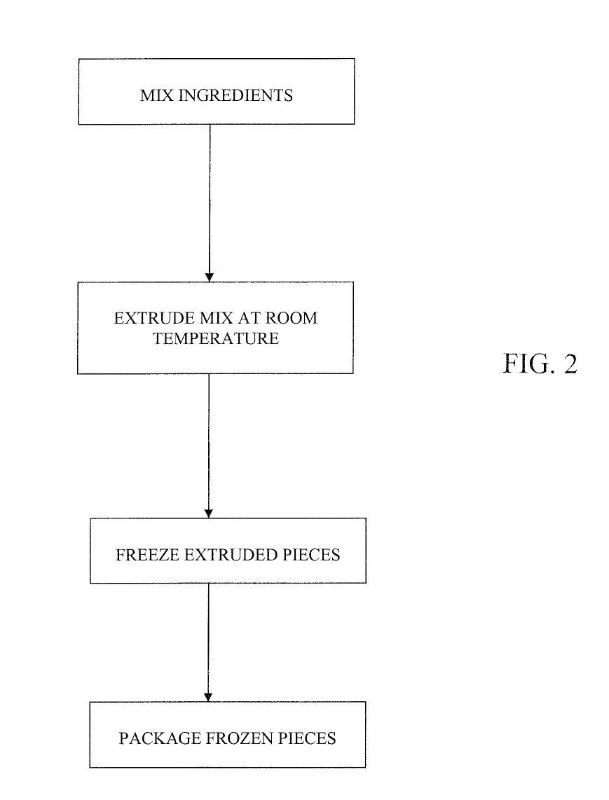

### DETAILED DESCRIPTION OF THE INVENTION

The cookie dough according to the invention can be presented in any shape, but preferably the cookie dough is shaped into cone-shaped pieces. The cookie dough is not intended for baking i.e., into cookies, and is therefore uniquely formulated. In particular, the present invention does not require traditional cookie dough ingredients such as baking powder, sodium bicarbonate and eggs. Instead, a certain mix of flours, sugars and fats preferably are used. Typically, the flour can be wheat, oat, rice buckwheat, or other flour. The flour may have a high or low protein content. The flour content is normally from about 10% to about 40%, preferably from about 25% to about 35% by weight of the dough.

The sugar used can be of any types. Such sugars include, but are not limited to, fructose, sucrose, sucralose, dextrose, corn syrup, glucose, lactose, molasses, or other mixtures thereof. Preferably, sucrose is used, such as, in the form of granulated sugar and as part of brown sugar. Moreover, sugar substitutes such as sorbitol or any other known sugar substitute can be added either in conjunction with, or as a substitute for, the sugar. Sucrose helps preserve the dough during refrigeration and freezing and allows the dough to harden and keep its substantial cone-shape. The sugar can be in an amount of from about 5% to about 50%, and preferably in an amount of from about 10% to about 40% by weight of the dough.

The type and temperature of the fat has an influence on production of the cookie dough according to our invention. In particular, the fat used in the dough composition should be a softened or liquid fat at room temperature. The fat can be of animal or plant origin, such as, butter oil, butter, margarine, corn oil, shortening, palm oil, sunflower oil, soya bean oil, coconut oil, palm kernel oil, cotton oil, peanut oil, olive oil, or mixtures thereof. The fat can be emulsified or stabilized with mono- or diglycerides or other emulsifiers. Typically, fat is present in an amount from about 5% to about 35%, preferably in an amount from about 10% to about 25% by weight of the dough.

In addition, the cookie dough should have a moisture or water content from about 2% to about 15%, preferably from about 5% to about 10% by weight.

The dough according to the invention may also contain natural or artificial flavoring agents. Such flavoring agents may include, but are not limited to, vanilla, vanilla flavor, cinnamon, cocoa powder, mint flavoring, clove, nutmeg, salt, or other such agents. Flavoring agents, when included, preferably are used in an amount of about 0.01% to about 2% by weight, and preferably from 0.1 to 1% by weight of the dough.

The dough also may contain other ingredients or inclusions. Such inclusions include, but are not limited to, chocolate, butterscotch, mint, candy or chocolate pieces, oat flake pieces, coconut flake pieces, ground nut pieces, nuts, peanut butter, oats, caramel, candy, toffee or mixtures thereof. The inclusions can be any edible size that fits in or around the cookie dough piece. Preferably, inclusions are present in the cookie dough in an amount of from about 5% to about 30%, and more preferably in an amount of from about 5% to about 25% by weight.

According to the invention, one cookie dough piece is formulated into an edible size for easy single bite consumption. Typically, a single cone-shaped piece has a base of from about 75″ to about 1″ in diameter and a height of from about 0.75″ to about 1″. Each cone-shaped piece of cookie dough typically weighs from about 0.10 ounces to about 0.5 ounces, and more preferably weighs from about 0.15 ounce to about 0.2 ounce.

In particular, each of the ingredients is folded into a mix in order. The mix is then mixed thoroughly for an extended period of time. Preferably, the temperature of the fats contained within the mix should be from between about 75° F. to about 85° F. Once extended mixing has been completed, a final folding rotation is performed, and the mix may be extruded through a known extruder. Once extruded, the dough bites are transported to a freezer for freezing.

The dough is prepared differently than with traditional drop cookie formulations. Specifically, each ingredient's temperature, and the sequence, speed, and mixing duration impact the extrusion process resulting in the inventions cone-shaped cookie dough.

According to the invention, each cone-shaped cookie dough piece preferably is bite-sized and of a predetermined size and weight. The predetermined diameter, weight and height of each cookie dough piece is practically accomplished when the dough is extruded at a precise and consistent temperature, consistency, speed and accuracy. This requires the cookie dough to be formulated accurately, mixed to a precise consistency, completed at a certain temperature that allows the dough to be extruded effectively to create cone-shaped cookie dough pieces. The dough mixture is then extruded through a die with multiple mm nozzles which the dough is forced through at a certain speed for a programmed amount of time and with the dough at a precise consistency and temperature. Cookie dough bites can also be prepared with additional coatings, inclusions or other ingredients either prior to or after freezing.

According to the invention, the dough forms cone-shaped cookie dough pieces having rounded edges. These cookie dough pieces are dropped onto a pan, frozen and prepared for packaging. The packaging is typically made of a synthetic material or based on a covered carton. Thereafter the dough can be stored either in a refrigerator or, preferably, a freezer. The shelf life of the dough in a typical freezer is several months.

Thus, the invention provides a ready-to-eat, frozen cookie dough treat having no eggs. Because no eggs are included in the dough, it can be readily enjoyed without baking, and without fear of egg-borne illnesses. In addition, the dough contains no baking soda or baking powder, at least partially because the dough is not intended for baking.

In a specific composition, the dough according to the invention is comprised of flour, sugar, butter, water, chocolate chips, vanilla extract, and salt. These ingredients are mixed together, extruded into individual bite-sized pieces, and frozen as discussed in more detail above, before being placed in the market.

1. A ready-to-eat, freezable cookie dough comprising flour; sugar; and one or more fats, said dough being substantially free of eggs and egg products.

2. The dough according to claim 1, wherein the flour content is from about 10% to about 40% by weight, the sugar content is from about 5% to about 50% by weight, and the fats content is from about 5% to about 35% by weight.

3. The dough according to claim 1, further comprising one or more inclusions.

4. The dough according to claim 3, wherein the inclusions content is from about 0.01% to about 2% by weight.

5. A ready-to-eat, freezable cookie dough consisting of:
one or more flours;
one or more sugars;
butter;
water;
chocolate chips;
vanilla extract; and
salt.
